(19) United States
(12) Patent Application Publication
(10) Pub. No.: US 2007/0247214 A1
(43) Pub. Date: Oct. 25, 2007

(54) METHODS FOR CONTROLLING CHARGE PUMP AND RELATED WORKING VOLTAGE GENERATING CIRCUITS

(76) Inventors: Hsiu-Ping Lin, Hsin-Chu Hsien (TW); Ming-Chung Chang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/380,194

(22) Filed: Apr. 25, 2006

(51) Int. Cl. G05F 1/10

(52) U.S. Cl. 327/536

(57) ABSTRACT

A method for controlling a charge pump having a plurality of switches, wherein the charge pump is for supplying a working voltage to a following stage, the method includes: adjusting the timing of a clock signal to generate an adjusted clock signal synchronized with a current consumption period of the following stage; generating a plurality of control signals according to the adjusted clock signal; and controlling the switching timings of the plurality of switches according to the plurality of control signals.

### BACKGROUND OF THE INVENTION

1. Field of the Invention

The present invention relates to techniques for alleviating the jitter of working voltage, and more particularly, to methods for controlling a charge pump and working voltage generating circuits using the same.

2. Description of the Prior Art

A charge pump is typically employed as a booster or a voltage multiplier. For example, the driving circuit of a LCD panel usually utilizes the charge pump to increase the output voltage supplied by a low voltage source (e.g., a lithium battery) in order to provide a working voltage having greater volts to high voltage components, such as the source driver IC and the Vcom driver IC.

Typically, the voltage polarities applied on the opposite terminals of the liquid crystal cell must be inversed every a predetermined period in order to prevent the liquid crystal cell from becoming polarization which permanently damages the liquid crystal cell. For example, in the line inversion scheme, pixels on the same scan line have identical polarity but two adjacent pixels on the same vertical scan line have opposite polarities. In the dot inversion scheme, the polarity of a pixel is opposite to that of each of the adjacent pixels.

At the time the polarity inversion operation of the LCD panel just begins, the power consumption of the Vcom driver IC and the source driver IC reach a maximum level so that the charge pump has a maximum load during such a period. As described previously, since the voltage polarities of the LCD panel have to be inversed periodically, the load of the charge pump also changes periodically thereby causing severe jitters on the output working voltage of the charge pump. As a result, the normal operations of the components operating under the working voltage, such as the Vcom driver IC and the source driver IC, are adversely affected.

### SUMMARY OF THE INVENTION

It is therefore an objective of the claimed invention to provide methods for controlling charge pump and related working voltage generating circuits to effectively alleviate the jitters of the output working voltage generated from the charge pump.

An exemplary embodiment of a method for controlling a charge pump having a plurality of switches is disclosed. The charge pump is for supplying a working to a LCD panel. The proposed method comprises: adjusting the timing of a clock signal to generate an adjusted clock signal synchronized with a polarity inversion period of the LCD panel; generating a plurality of control signals according to the adjusted clock signal; and controlling the switching timings of the plurality of switches according to the plurality of control signals.

An exemplary embodiment of a working voltage generating circuit is disclosed comprising: a charge pump having a plurality of switches; an adjusting circuit for adjusting the timing of a clock signal to generate an adjusted clock signal synchronized with a polarity inversion period of a LCD panel; and a control signal generator coupled to the adjusting circuit and the charge pump for generating a plurality of control signals according to the adjusted clock signal to control the switching timings of the plurality of switches.

An exemplary embodiment of a method for controlling a charge pump having a plurality of switches is disclosed. The charge pump is for supplying a working voltage to a following stage. The proposed method comprises: adjusting the timing of a clock signal to generate an adjusted clock signal synchronized with a current consumption period of the following stage; generating a plurality of control signals according to the adjusted clock signal; and controlling the switching timings of the plurality of switches according to the plurality of control signals.

An exemplary embodiment of a working voltage generating circuit is disclosed comprising: a charge pump having a plurality of switches; an adjusting circuit for adjusting the timing of a clock signal to generate an adjusted clock signal synchronized with a current consumption period of the following stage; and a control signal generator coupled to the adjusting circuit and the charge pump for generating a plurality of control signals according to the adjusted clock signal to control the switching timings of the plurality of switches.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a working voltage generating circuit according to an exemplary embodiment of the present invention.

FIG. 2 is a schematic diagram of the charge pump of FIG. 1 according to a preferred embodiment of the present invention.

FIG. 3 is a schematic diagram of a control signal generator cooperating with the charge pump of FIG. 2 according to an exemplary embodiment of the present invention.

FIG. 4 is a timing diagram illustrating the operations of the charge pump of FIG. 2 according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

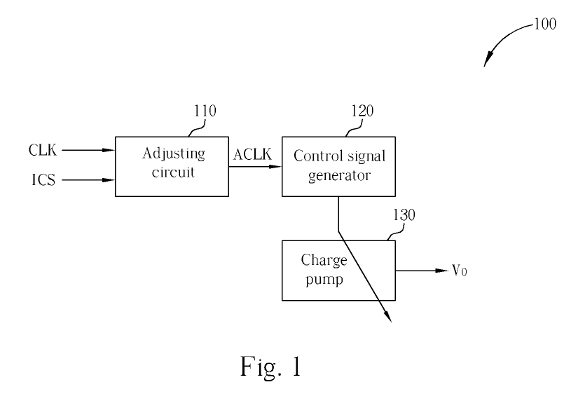

Please refer to FIG. 1, which shows a simplified block diagram of a working voltage generating circuit 100 according to an exemplary embodiment of the present invention. As shown, the working voltage generating circuit 100 comprises an adjusting circuit 110, a control signal generator 120, and a charge pump 130. For the purpose of explanatory convenience in the following description, it is herein assumed that the working voltage generating circuit 100 is applied in a LCD panel to generate a working voltage Vo required by certain components of the LCD panel, such as the Vcom driver IC and the source driver IC of the LCD panel. In the working voltage generating circuit 100, the adjusting circuit 110 is arranged for adjusting the timing of a system clock signal CLK to generate an adjusted clock signal ACLK synchronized with a polarity inversion period of the LCD panel. The control signal generator 120 then controls the operations of the charge pump 130 according to the adjusted clock signal ACLK. Hereinafter, operations and implementations of the control signal generator 120 and the charge pump 130 are described in further detail.

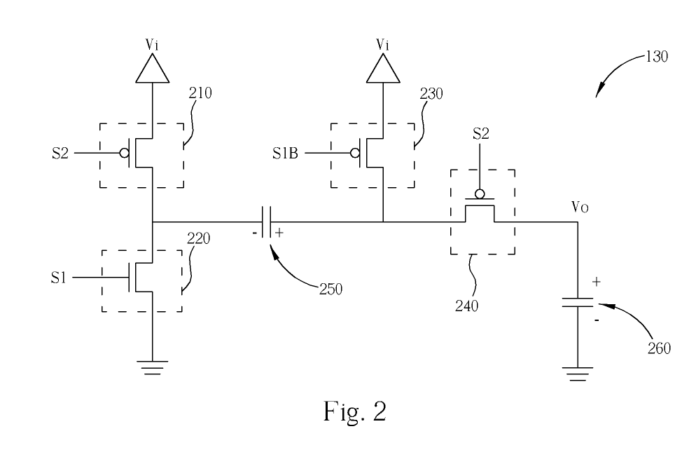

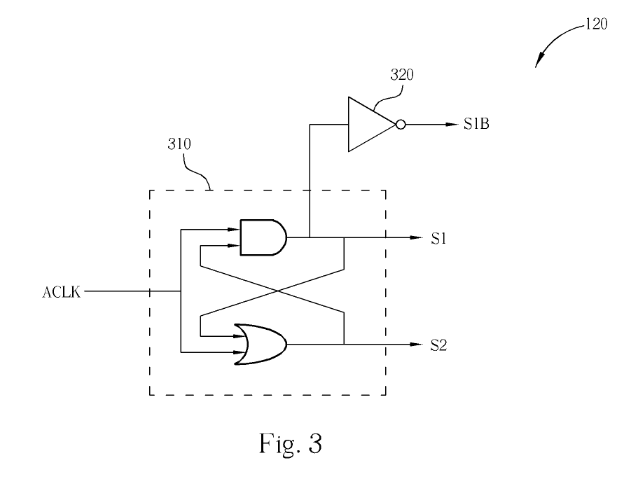

Please refer to FIG. 2 and FIG. 3. FIG. 2 shows a schematic diagram of the charge pump 130 according to a preferred embodiment of the present invention. FIG. 3 depicts a schematic diagram of the control signal generator 120 cooperating with the charge pump 130 of FIG. 2 according to an exemplary embodiment of the present invention. In this embodiment, the charge pump 130 is a switch-capacitor type charge pump comprising a plurality of switches and a plurality of capacitors. The charge pump 130 functions as a booster or a voltage multiplier. Specifically, the charge pump 130 is arranged for generating the working voltage Vo having relative higher volts according to an output voltage Vi having relative lower volts supplied from a voltage source, such as a lithium battery (not shown). As shown in FIG. 2, the charge pump 130 comprises four switches 210, 220, 230, and 240, and two capacitors 250 and 260. The capacitor 250 is also referred to as a flying capacitor while the capacitor 260 is also referred to as a regulator capacitor. As shown, the switches 210, 230, and 240 of the charge pump 130 may be implemented by PMOS transistors, and the switch 220 may be implemented by a NMOS transistor. In FIG. 2, S1, S1B, and S2 denote a plurality of control signals generated by the control signal generator 120. In this embodiment, the control signal S1 is a high-active signal and the control signals S1B and S2 are both low-active signals.

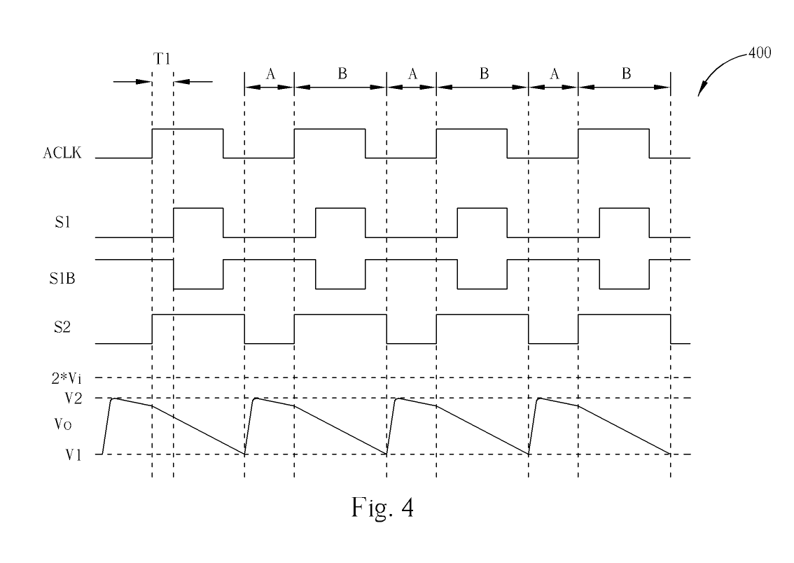

As shown in FIG. 3, the control signal generator 120 of this embodiment comprises a RS latch 310 and a NOT gate 320. The RS latch 310 is arranged for generating the two control signals S1 and S2 according to the adjusted clock signal ACLK generated by the adjusting circuit 110. The NOT gate 320 is arranged for generating another control signal S1 control signal S1B which is inverted with respect to the control signal S1. As shown in FIG. 2, the control signal S1 is employed to control the switch 220 of the charge pump 130; the control signal S1 control signal S1B is employed to control the switch 230; and the control signal S2 is employed to control the switches 210 and 240. The generation of the adjusted clock signal ACLK made by the adjusting circuit 110 will be explained later. Hereinafter, the interactions between the control signal generator 120 and the charge pump 130 are firstly described with reference to FIG. 4.

FIG. 4 is a timing diagram 400 illustrating the operations of the charge pump 130 under the control of the control signal generator 120 according to an exemplary embodiment of the present invention. As illustrated in the timing diagram 400, there is a timing gap T1 between the active period of the control signal S1 and the active period of the control signal S2 due to both the AND gate and the OR gate of the RS latch 310 introduce a few delay. Such a design is able to prevent the voltage source from shorting since the switches 210 and 220 do not turn on simultaneously. For easily describing the variation of the working voltage Vo generated by the charge pump 130, it is herein assumed that the flying capacitor 250 and the regulator capacitor 260 of the charge pump 130 have the same capacitance, and the current consumption of the following stage of the charge pump 130, such as the Vcom driver IC and the source driver IC, is fixed. In operations, when the switches 220 and 230 of the charge pump 130 are turn on and the switches 210 and 240 are turn off, the negative terminal (−) of the flying capacitor 250 is coupled to ground via the switch 220 while the positive terminal (+) of the flying capacitor 250 is coupled to the voltage source through the switch 230 to charge toward the voltage level Vi. On the other hand, when the switches 220 and 230 are turn off and the switches 210 and 240 are turn on, the negative terminal of the flying capacitor 250 is coupled to the voltage source via the switch 210 while the positive terminal of the flying capacitor 250 is coupled to the regulator capacitor 260 via the switch 240 to conduct electric charges to the regulator capacitor 260.

As shown in the timing diagram 400, when the switches 210 and 240 are turn on (e.g., the interval A in FIG. 4), the flying capacitor 250 and the regulator capacitor 260 are coupled to share electric charges to each other. At the moment the flying capacitor 250 is just coupled to the regulator capacitor 260, the voltage at the positive terminal of the regulator capacitor 260 (i.e., the working voltage Vo) immediately pulls up from V1 to V2 which is near two times of Vi due to the charge sharing effect of the flying capacitor 250. Then, the following stage of the charge pump 130 consumes the electric charges stored in the flying capacitor 250 and the regulator capacitor 260, and the working voltage Vo outputted from the charge pump 130 gradually goes down. When the switches 210 and 240 are turn off (e.g., the interval B in FIG. 4), the flying capacitor 250 disconnects from the regulator capacitor 260 so as to repeat the foregoing charge operation. During this period, since only the regulator capacitor 260 of the charge pump 130 supplies electric charges to the following stage, the drop speed of the working voltage Vo within the interval B is greater than that within the interval A. In this case, since the flying capacitor 250 and the regulator capacitor 260 are assumed to have the same capacitance and the current consumption of the following stage of the charge pump 130 is assumed to be a fixed value, the drop speed of the working voltage Vo within the interval B is twice of that within the interval A.

However, the current consumption of the following stage of the charge pump 130 is not fixed in practical applications. The working voltage Vo drops faster as the current consumption of the following stage of the charge pump 130 increases. As in the foregoing illustrations, at the time the polarity inversion operation of the LCD panel just begins, the power consumption of the Vcom driver IC and the source driver IC reach the maximum level. Thus, the charge pump 130 has a maximum load during such a period at which the polarity inversion operation of the LCD panel just begins. If the polarity inversion operation of the LCD panel begins within the interval B of the timing diagram 400, the working voltage Vo drops even faster due to the current consumption of the Vcom driver IC and the source driver IC increase significantly. Once the working voltage Vo drops too fast (this is equivalent to that unignorable noise presents in the working voltage Vo), normal operations of the following stage of the charge pump 130 are adversely affected.

To effectively alleviate the jitter of the working voltage Vo, the adjusting circuit 110 and the control signal generator 120 control the switching timing of each of the switches in the charge pump 130 so that the period at which the flying capacitor 250 is coupled to the regulator capacitor 260 (i.e., the interval A in FIG. 4) corresponds the period at which the charge pump 130 has the maximum load. As described previously, the charge pump 130 has the maximum load during the period at which the polarity inversion operation of the LCD panel just begins.

Specifically, the adjusting circuit 110 adjusts the timing of the system clock signal CLK of the LCD panel to generate an adjusted clock signal ACLK synchronized with the polarity inversion period of the LCD panel. In a preferred embodiment, the adjusting circuit 110 receives a polarity inversion control signal ICS for controlling the polarity inversion period of the LCD panel, and detects the phase difference between the system clock signal CLK and the polarity inversion control signal ICS. Then, the adjusting circuit 110 compensates a proper delay on the system clock signal CLK according to the detecting result so as to synchronize the resulting adjusted clock signal ACLK with the polarity inversion control signal ICS. In other words, the adjusting circuit 110 may generate the adjusted clock signal ACLK by delaying the timing of the system clock signal CLK. It should be appreciated by those skilled in the art that the adjusted clock signal ACLK can be regarded as being synchronized with the polarity inversion period of the LCD panel as long as the adjusted clock signal ACLK is synchronized with the polarity inversion control signal ICS. As a result, by controlling the switching timings of the switches of the charge pump 130 using the control signals S1, S1B, and S2 generated from the control signal generator 120 according to the adjusted clock signal ACLK, the period at which the flying capacitor 250 is coupled to the regulator capacitor 260 (i.e., the interval A in FIG. 4) can correspond to the period at which the polarity inversion operation of the LCD panel just begins so as to alleviate the jitters of the working voltage Vo.

In practice, the adjusting circuit 110 may be implemented with a programmable delay stage, a delay-locked loop, or a phase-locked loop. Please note that the number of switches arranged in the charge pump 130 and the implementation of individual switch are not limited to that illustrated in the foregoing embodiments. For example, the number of the flying capacitor or the regulator capacitor can also be extended to two or more than two.

In addition to the LCD panel, the disclosed architecture of the working voltage generating circuit 100 and the associated control method of the charge pump 130 can also be applied in other applications where the variation of current consumption of the following stage of the charge pump has a periodical pattern to effectively reduce the jitter on the voltage output from the charge pump. As a result, the following stage of the charge pump can operate normally thereby improving the system performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a charge pump having a plurality of switches, wherein the charge pump is for supplying a working voltage to a LCD panel, the method comprising:
adjusting the timing of a clock signal to generate an adjusted clock signal synchronized with a polarity inversion period of the LCD panel;
generating a plurality of control signals according to the adjusted clock signal; and
controlling the switching timings of the plurality of switches according to the plurality of control signals.

2. The method of claim 1, where the step of adjusting the timing of the clock signal comprises:
receiving a polarity inversion control signal that controls the polarity inversion period; and
delaying the timing of the clock signal to synchronize the resulting adjusted clock signal with the polarity inversion control signal.

3. A working voltage generating circuit comprising:
a charge pump having a plurality of switches;
an adjusting circuit for adjusting the timing of a clock signal to generate an adjusted clock signal synchronized with a polarity inversion period of a LCD panel; and
a control signal generator coupled to the adjusting circuit and the charge pump for generating a plurality of control signals according to the adjusted clock signal to control the switching timings of the plurality of switches.

4. The working voltage generating circuit of claim 3, wherein the adjusting circuit receives a polarity inversion control signal, which controls the polarity inversion period, and delays the timing of the clock signal to synchronize the resulting adjusted clock signal with the polarity inversion control signal.

5. The working voltage generating circuit of claim 3, wherein the control signal generator comprises a RS latch.

6. A method for controlling a charge pump having a plurality of switches, wherein the charge pump is for supplying a working voltage to a following stage, the method comprising:
adjusting the timing of a clock signal to generate an adjusted clock signal synchronized with a current consumption period of the following stage;
generating a plurality of control signals according to the adjusted clock signal; and
controlling the switching timings of the plurality of switches according to the plurality of control signals.

7. The method of claim 6, where the step of adjusting the timing of the clock signal comprises:
receiving a periodic signal corresponding to the current consumption period of the following stage; and
delaying the timing of the clock signal to synchronize the resulting adjusted clock signal with the periodic signal.

8. A working voltage generating circuit comprising:
a charge pump having a plurality of switches;
an adjusting circuit for adjusting the timing of a clock signal to generate an adjusted clock signal synchronized with a current consumption period of the following stage; and
a control signal generator coupled to the adjusting circuit and the charge pump for generating a plurality of control signals according to the adjusted clock signal to control the switching timings of the plurality of switches.

9. The working voltage generating circuit of claim 8, wherein the adjusting circuit receives a periodic signal corresponding to the current consumption period of the following stage, and delays the timing of the clock signal to synchronize the resulting adjusted clock signal with the periodic signal.

10. The working voltage generating circuit of claim 8, wherein the control signal generator comprises a RS latch.
